(19) United States
(12) Patent Application Publication
(10) Pub. No.: US 2012/0222915 A1
(43) Pub. Date: Sep. 6, 2012

(54) RETRACTABLE LADDER

(76) Inventor: Richard C. BLASKA, San Francisco, CA (US)

(21) Appl. No.: 13/408,929

(22) Filed: Feb. 29, 2012

Related U.S. Application Data
(60) Provisional application No. 61/448,961, filed on Mar. 3, 2011.

(51) Int. Cl. E06C 9/08

(52) U.S. Cl. 182/97

(57) ABSTRACT

A retractable ladder assembly for use in an elevator pit is disclosed. The retractable ladder assembly includes a ladder having spaced-apart parallel stiles coupled together via a plurality of stacked horizontally-disposed rungs. At least one pivot arm having a first end is coupled to the ladder. A second end of the pivot arm is adapted for coupling to a wall in the pit. The ladder assembly further includes a lift assist mechanism having a first end coupled to the ladder, and a second end for coupling to the wall. The lift assist mechanism is operative to assist in manually pivoting the ladder to a retractable state.

RELATED APPLICATION(S)

This application claims benefit of priority to Provisional U.S. patent application Ser. No. 61/448,961, filed Mar. 3, 2011, the aforementioned priority application being hereby incorporated by reference in its entirety.

### TECHNICAL FIELD

The disclosure herein relates to elevator services and structures, and more particularly a retractable elevator pit ladder.

### BACKGROUND

Most if not all elevators have a hoistway area, commonly referred to as a pit, which extends some distance below the lowest landing served by an elevator. Such elevator pits commonly have a depth from three to seven feet or more. Access to the floor of the elevator pit is often required for inspection, maintenance and cleaning Most elevator pits do not have an access door as they are located below the grade of the structure. Traditionally, access to an elevator pit is accomplished through the elevator entrance at the lowest landing. With the elevator doors opened and the car moved out of the way, the technician climbs down a fixed and stationary ladder to the pit floor.

In some jurisdictions, applicable codes allow for an elevator pit ladder to have a reduced centerline of rung-to-wall or obstacle dimension of as little as 4.5 inches. Other jurisdictions require the centerline of rung-to-wall or obstacle dimension to be the full OSHA mandated 7 inches. On many new and existing elevator installations, there is insufficient clearance between the moving car and the building structure to fit a fixed, stationary ladder with the code-prescribed centerline of rung-to-wall or obstacle dimension.

Thus, the need exists for a retractable elevator pit ladder that can provide the code minimum centerline of rung-to-wall or obstacle dimension yet provide the necessary clearance to the operating elevator car.

### BRIEF DESCRIPTION OF THE DRAWINGS

Embodiments of the disclosure are illustrated by way of example, and not by way of limitation, in the figures of the accompanying drawings and in which like reference numerals refer to similar elements and in which:

FIG. 1 illustrates one embodiment of a retractable elevator pit ladder in front and side elevation;

FIG. 2 illustrates a detail view of the area identified as 2-2 in FIG. 1, and showing a deployment pivot arm with a pull-pin deployment and locking mechanism;

FIG. 3A illustrates a detail view of the area identified as 3-3 in FIG. 1, and showing a hinge pivot arm activated safety switch;

FIG. 3B illustrates a top plan view along lines ‘A-A’ of FIG. 3A; and

FIG. 4 illustrates a detail view of the area identified as 4-4 in FIG. 1, and showing a pneumatic spring-load assist mechanism.

### DETAILED DESCRIPTION

Embodiments of a retractable ladder assembly for use in an elevator pit are disclosed. In one embodiment, the retractable ladder assembly includes a ladder having spaced-apart parallel stiles coupled together via a plurality of stacked horizontally-disposed rungs. At least one pivot arm having a first end is coupled to the ladder. A second end of the pivot arm is adapted for coupling to a wall in the pit. The ladder assembly further includes a lift assist mechanism having a first end coupled to the ladder, and a second end for coupling to the wall. The lift assist mechanism is operative to assist in manually pivoting the ladder to a retractable state. Among other things, this configuration provides for ease of use while maintaining stringent building code requirements.

In another embodiment, the retractable ladder assembly includes at least one stile, the stile being formed with a deployment hole, at least one deployment arm, and a deployment mechanism mounted on the deployment arm. The deployment mechanism couples the deployment arm to the deployment hole. The deployment mechanism further includes an operating handle and a pin configured to detachably engage the deployment hole in the deployment arm in response to an activation of the operating handle.

Embodiments further provide for a ladder assembly having an electrical safety switch mechanism having a hinge pivot arm, and a switch including a biased plunger configured to slidably engage the hinge pivot arm to actuate the switch.

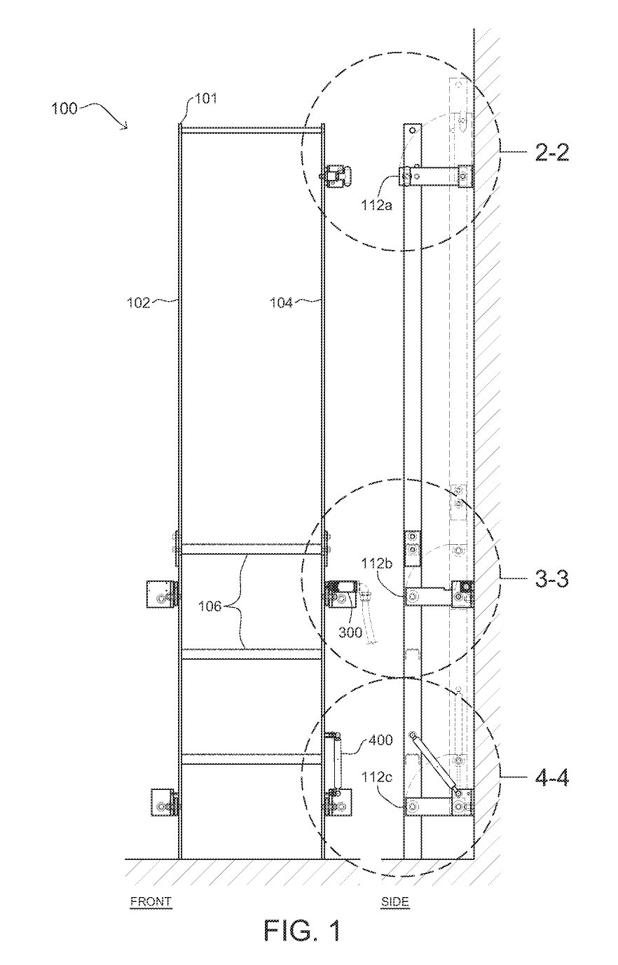

FIG. 1 illustrates a retractable ladder assembly, generally designated 100, in both front and side elevation perspectives. The ladder assembly includes a ladder 101 having a pair of parallel spaced-apart stiles 102 and 104 formed of a rigid metal, such as steel or aluminum. Ladder rungs 106 are interposed in a fixed relationship between the stiles in a regular stacked relationship. As more fully described below, the ladder assembly 100 includes a plurality of pivots 112a-112c to effect retractable operation of the ladder 101 with respect to a pit wall 110. The ladder assembly also includes a safety switch mechanism 300 and a lift assist mechanism 400, as more fully described below.

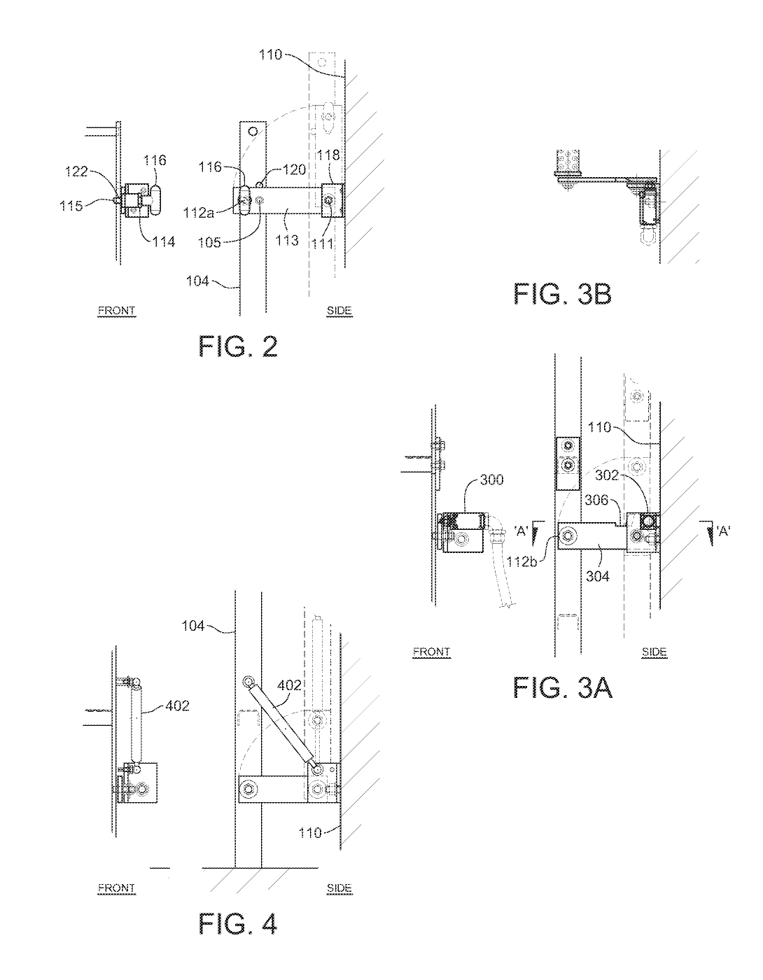

Referring now to FIG. 2, additional details of one embodiment of a pivot 112a are shown. While only one pivot assembly is described below, it is to be understood that at least one pair of pivots are disposed on each stile of the ladder. Each pivot includes a rectangular shaped deployment pivot arm 113 having one end pivotably attached to a ladder stile 104, with pivot 105, while the other end is pivotably attached to a mount 118 attached to the pit wall 110 with pivot 111. A pull-pin deployment and locking mechanism 114 is mounted on the pivot arm, and includes a spring-loaded pin 115 having an operating handle 116 that detachably engages a first complementally-formed hole 120 in the stile 104 when in the “up”, or retracted position, and locks the ladder in a deployed position by detachably engaging hole 122 with the ladder extended from the wall 110. The pull-pin deployment and locking mechanism is reversible with the ability to locate the mechanism on the opposite side of the ladder, which allows the ladder to be installed on either side of the elevator car. In an embodiment, a plurality of holes is provided on the stile and the pin may be detachably configured to deploy and engage each of the plurality of deployment holes in respective deployed and retracted states.

FIG. 3A illustrates further detail of one embodiment of the hinge pivot arm activated safety switch mechanism 300, shown in area 3-3 of FIG. 1. The safety switch mechanism, in one embodiment, includes a micro-switch that mounts to a platform on the wall 110 proximate one of the pivot assemblies 112b. The switch employs a biased plunger 302 that actuates switch contacts (not shown) to make or break electrical connection to an elevator power circuit when engaged in axial displacement (analogous to the locking pin mechanism described above). The plunger 302 includes a roller, and is depressible through lateral contact of a sliding beveled plate, such as a portion of the pivot arm 304. An opening 306 formed in the pivot arm is configured to align over the plunger while the ladder 101 is in a refracted position. Many of the features described above are also seen in FIG. 3B, which shows a top plan view along lines ‘A-A’ of FIG. 3A.

The unique beveling configuration of the pivot arm 304 cooperates with the location and design of the plunger 302 such that during deployment of the ladder 101, a portion of the pivot arm engages the roller plunger safety switch mechanism, effecting a forced open movement of the switch contacts. These contacts are wired in series with an elevator safety circuit, whereby an open circuit prevents the movement of the elevator car. The safety switch mechanism allows for the normal operation of the elevator car whilst the ladder is in the retracted position (phantom side view of FIG. 1) and prevents the operation of the elevator car whilst the ladder is in the deployed position. Embodiments provide for deploying the switch contacts in a closed position when the ladder is refracted.

FIG. 4 illustrates further detail regarding the lift assist mechanism of area 4-4 of FIG. 1. In one embodiment, the lift assist mechanism comprises a gas spring such as a piston-actuated air cylinder 402 that expands and contracts with a relatively stable level of resistance. One end of the cylinder couples to a ladder stile, such as that at 104, while the opposite end mounts to a support plate fixed to the pit wall 110. The cylinder beneficially reduces the amount of manual force required to retract and deploy the ladder.

In operation, a user desiring to access the elevator pit to perform servicing and/or repairs merely grasps the locking handle 116 to pull it out of its locked position and begin deployment of the ladder 101. With the ladder unlocked from its retracted position, the user exerts a small amount of force on the ladder outwardly from the wall. Although the ladder may weigh hundreds of pounds due to its heavy-duty metallic construction, the resistance provided by the air cylinder 402 enables a small amount of force from the user to deploy the ladder. As the pivot arms swing the ladder into a fully deployed vertical position, the locking mechanism 114 engages its locked position, and a portion of the medial pivot arm 304 slides over and depresses the switch plunger 302, thus actuating the switch contacts to cut power to the elevator service car. At this point, an elevator service-person may safely access the pit via the ladder to conduct the desired servicing and/or repair.

Once the servicing is complete, the user climbs back up the ladder, and from the elevator entrance, re-grasps the locking pin handle to free the locking pin from its locking hole. Once unlocked, a slight inwardly applied force from the user (assisted in large part by the pneumatic assist cylinder) is sufficient to pivotably bring the ladder 101 back to a retracted state against the pit wall. Once locked to the wall, the medial pivot arm opening releases the micro-switch plunger from its actuated position, thus restoring the switch contacts to their default state and allowing power back to the elevator car.

Those skilled in the art will recognize the various benefits and advantages afforded by the disclosure herein. The retractable ladder assembly is operable from the location of the elevator entrance, which is at the functional top of the ladder. Further, the assembly includes a unique mechanism of raising (retracting) and lowering (deploying) the ladder through the manual action of a user's single extended arm and hand. Moreover, the ladder assembly is capable of locking so as to maintain the ladder in either the retracted or deployed positions. Additionally, the assembly provides a switching device to prevent the movement of the elevator when the ladder is deployed (as it will be in the path of the moving car).

While the invention has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof Accordingly, the specification and drawings are to be regarded in an illustrative rather than a restrictive sense.

We claim:

1. A retractable ladder assembly for use in an elevator pit, the retractable ladder assembly comprising:
a ladder having spaced-apart parallel stiles, the stiles coupled together via a plurality of stacked horizontally-disposed rungs;
a pivot arm having a first end coupled to the ladder, and a second end for coupling to a wall in the pit; and
a lift assist mechanism having a first end coupled to the ladder, and a second end for coupling to the wall, the lift assist mechanism operative to assist in manually pivoting the ladder to a retractable state.

2. The ladder assembly of claim 1, wherein the lift assist mechanism further comprises a gas spring.

3. The ladder assembly of claim 2, wherein the gas spring comprises a piston-actuated cylinder, and wherein the cylinder includes a face that is configured to couple to one of the stiles.

4. The ladder assembly of claim 3, wherein the elevator pit is bounded by a wall, the wall having a fixed support plate, and wherein the gas spring includes a face that is configured to couple to the fixed support plate.

5. The ladder assembly of claim 1, wherein the lift assist mechanism further includes a locking handle.

6. The ladder assembly of claim 1 wherein one of the stiles is formed with a deployment hole, the ladder assembly further comprising:
a deployment arm; and
a deployment mechanism mounted on the deployment arm and coupling the deployment arm to the deployment hole, the deployment mechanism including
an operating handle, and
a pin configured to detachably engage the deployment hole in response to an activation of the operating handle.

7. The ladder assembly of claim 1, further comprising an electrical safety switch mechanism having a hinge pivot arm, and a switch including a biased plunger configured to slidably engage the hinge pivot arm to actuate the switch.

8. A ladder assembly comprising:
at least one stile formed with a deployment hole;
a deployment arm; and
a deployment mechanism mounted on the deployment arm and coupling the deployment arm to the deployment hole, the deployment mechanism including
an operating handle, and
a pin configured to detachably engage the deployment hole in response to an activation of the operating handle.

9. The ladder assembly of claim 8 wherein the deployment mechanism further includes a spring coupled to the pin, the pin exhibiting a spring-loaded response upon activation of the operating handle.

10. The ladder assembly of claim 8 wherein the deployment arm is configured to couple to an elevator wall mount.

11. The ladder assembly of claim 8 wherein the pin is further configured to lock the ladder into a deployed position responsive to being engaged with the deployment hole.

12. The ladder assembly of claim 8, further comprising a plurality of deployment holes formed on the stile, and wherein the pin is configured to detachably deploy and engage each of the plurality of deployment holes in respective deployed and retracted states.

13. The ladder assembly of claim 8 further comprising a pivot disposed on the stile, and wherein the pivot is configured to pivotably attach the deployment mechanism to the stile.

14. The ladder assembly of claim 8 wherein the deployment mechanism is reversible.

15. The ladder assembly of claim 8, wherein the pin is configured to detach from the deployment hole in response to the operating handle being placed in an unactivated position.

16. The ladder assembly of claim 8, further comprising a lift assist mechanism having a first end coupled to the ladder, and a second end for coupling to the wall, the lift assist mechanism operative to assist in manually pivoting the ladder to a retractable state.

17. A retractable ladder assembly for use in an elevator pit, the retractable ladder assembly comprising:
a ladder having spaced-apart parallel stiles, the stiles coupled together via a plurality of stacked horizontally-disposed rungs;
at least one pivot arm having a first end coupled to the ladder, and a second end for coupling to a wall in the pit; and
an electrical safety switch mechanism comprising
a hinge pivot arm coupled to one of the stiles, and
a switch including a biased plunger configured to slidably engage the hinge pivot arm to actuate the switch.

18. The retractable ladder assembly of claim 17 wherein the switch further includes a set of contacts configured to maintain an open position responsive to the ladder being placed in a deployed position.

19. The electrical switch mechanism of claim 18, wherein the set of switch contacts are further configured to maintain a closed position responsive to the ladder being placed in an undeployed position.

20. The electrical switch mechanism of claim 17 wherein the ladder further comprises a lift assist mechanism having a first end coupled to the ladder, and a second end for coupling to the wall, and a deployment mechanism mounted on the deployment arm and coupling the deployment arm to the deployment hole.
